(19) United States
(12) Patent Application Publication
(10) Pub. No.: US 2012/0013520 A1
(43) Pub. Date: Jan. 19, 2012

(54) Ultra-Wide Band Monopole Antenna

(75) Inventors: Jonathan B. Hanson, Raymond, ME (US); John L. Schadler, Raymond, ME (US)

(73) Assignee: SPX CORPORATION, Charlotte, NC (US)

(21) Appl. No.: 13/182,099

(22) Filed: Jul. 13, 2011

Related U.S. Application Data
(60) Provisional application No. 61/363,839, filed on Jul. 13, 2010.

(51) Int. Cl. H01Q 1/48

(52) U.S. Cl. 343/848

(57) ABSTRACT

A broad-band monopole antenna for high voltage environments is provided. The monopole antenna includes a ground plane, a plurality of flat radiator elements and an electrical conductor. The ground plane has a flat upper surface, a lower surface, a smoothly-radiused outer edge and a hole centrally disposed through the upper and lower surfaces. Each flat radiator element has a thickness, a straight inner edge and a semicircular outer edge. The plurality of flat radiator elements are interconnected along each inner edge and symmetrically arranged about a vertical axis centered on the ground plane hole. The electrical connector extends through the ground plane hole and is coupled to the radiator elements.

### CROSS-REFERENCE TO RELATED APPLICATIONS

This application claims priority to U.S. Provisional Patent Application Ser. No. 61/363,839, entitled “Ultra-Wide Band Monopole Antenna” and filed on Jul. 13, 2010, the disclosure of which is incorporated herein by reference in its entirety.

### FIELD OF THE INVENTION

The present invention relates generally to radio frequency (RF) signal antennas. More particularly, the present invention relates to ultra-wideband, omni-directional RF antennas for data acquisition and monitoring systems.

### BACKGROUND OF THE INVENTION

Dipole antennas are well known radiators of electromagnetic (EM) signals at radio frequencies (RF). More particularly, dipoles radiators usually include two similar conductive elements, physically oriented oppositely to one another, and are usually excited, at respective nodes positioned near their closest point to one another, by an RF EM signal, with similar signals of opposite polarity applied to the respective nodes. Alternatively, one of the two elements making up the dipole can receive an RF EM signal while the other is held at a constant potential, such as at ground potential.

Dipoles can have any physical length, from a small fraction of a wavelength of the RF EM excitation signal up to a large multiple of the signal wavelength. A number of dipoles have a size which is a quarter wavelength for each of the two elements, i.e., a half wavelength overall, calculated with reference to the characteristic propagation rate of EM signals along the dipole elements. This size has the property that any signal energy reflected back from the far ends of the elements tends to return to the drive node in phase with the signal arriving from the antenna's EM signal source at the excitation node at the time of return, and thus to reinforce that signal rather than to degrade it. A slender, rotationally symmetric dipole in an environment similar to free space tends to radiate an EM signal in a pattern of energy density resembling a uniform torus, with the axes of rotational symmetry of the dipole and the torus generally coinciding.

A type of antenna useful as an alternative to a dipole is a monopole. A monopole is essentially one of the two elements of a dipole. A monopole receives excitation by an RF EM signal, typically at a drive node, such as the bottom end of a vertical conductor, and the signal then propagates away from the drive node. Some part of the applied EM signal energy is coupled to free space, i.e., is radiated from the monopole. A conductive surface proximal to, isolated from, and approximately perpendicular to the drive node typically functions as a reflector so that the signal radiated from the monopole and the reflected signal resemble the emission of a dipole. The reflector configuration varies, and any available conductive surface may serve as a reflector. Specifically, for example, as with an automobile radio, a whip antenna functions as a vertically-oriented monopole, while a metal surface of the automobile approximates a ground plane and thus serves as the reflector. The surface of the earth can also serve as a radiator, as can a metal disk, a wire mesh screen, one or more horizontal radial elements similar in construction and size to the monopole antenna itself, etc.

Measurement of remote phenomena is increasingly used for control and protection of system components. A recent application of this concept is sensing voltage, current, power, temperature, line sag, tension, and other conditions associated with long-distance, high-voltage, three-phase conductors, e.g., commercial power lines, suspended above the ground from elevated towers or poles. A challenge in this particular application involves transferring the measurement data to a central site. Using copper conductors for telemetering this data is generally not feasible, because, for example, signal conductors leading down from the elevated lines could attract lightning, could provide deadly shock hazards in event of system faults, etc. Fiber optic signal conductors have other limitations, including, for example, unintended conductivity when their coverings become dirty. Coupling telemetry signals from multiple sensor nodes onto the power lines themselves for remote reception has other limitations, such as, for example, link length, modulation-produced line radiation that potentially causes interference to radio receivers nearby, etc.

An alternative to the above includes attaching a data acquisition and telemetry system to one or more of the power lines, and periodically communicating acquired data to a central site using, for example, an established cellular phone system. In one known system these sensors are roughly toroidal in shape, being split into two C-shapes that can be clamped together to surround one phase wire. However, this known system uses a patch antenna, which is mounted on the toroid such that the radiated signals are highly directional, e.g., along the longitudinal axis of the phase wire. This arrangement reduces the effectiveness of the data acquisition and telemetry system, because the closest cellular tower may be in the opposite direction and thereby shielded by the body of the toroid. Additionally, the high-voltage nature of this environment impacts the effectiveness of the antenna.

What is needed is an omnidirectional, ultra-wide bandwidth antenna for remote sensing in high-voltage outdoor environments.

### SUMMARY OF THE INVENTION

Embodiments of the present invention advantageously provide a broad-band monopole antenna for high voltage environments.

In one embodiment, the monopole antenna includes a ground plane, a plurality of flat radiator elements and an electrical conductor. The ground plane has a flat upper surface, a lower surface, a smoothly-radiused outer edge and a hole centrally disposed through the upper and lower surfaces. Each flat radiator element has a thickness, a straight inner edge and a semicircular outer edge. The plurality of flat radiator elements are interconnected along each inner edge and symmetrically arranged about a vertical axis centered on the ground plane hole. The electrical connector extends through the ground plane hole and is coupled to the radiator elements.

In another embodiment, the monopole antenna includes a ground plane, a single flat radiator and an electrical conductor. The ground plane includes a flat upper surface, a lower surface, a smoothly-radiused outer edge and a hole centrally disposed through the upper and lower surfaces. The single flat radiator has a thickness and a circular outer edge, and is arranged about a vertical axis centered on the ground plane hole. The electrical connector extends through the ground plane hole and is coupled to the radiator.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The above and other aspects and features of the present invention will become more readily apparent by describing in further detail exemplary embodiments thereof with reference to the accompanying drawings, in which:

FIG. 1 depicts a perspective view of an embodiment of an antenna disposed on an overhead high voltage data acquisition and monitoring system in accordance with an embodiment of the present invention;

FIGS. 2A-2L depict perspective views of monopole antennas in accordance with various embodiments of the present invention;

FIGS. 3A-3F depict polar graphs of vertical gain versus azimuth, illustrating propagation patterns for the antennas of FIG. 2A-2F, in accordance with embodiments of the present invention;

FIGS. 4 and 5 depict rectangular coordinate graphs of voltage standing wave ratio (VSWR) versus frequency for the antennas of FIGS. 2A-2F, in accordance with embodiments of the present invention;

FIG. 6 is a polar graph of vertical gain versus elevation, illustrating propagation patterns for the antenna of FIG. 2D in accordance with embodiments of the present invention; and

FIGS. 7A-7D shows various radomes according to embodiments of the present invention.

### DETAILED DESCRIPTION OF THE INVENTION

Embodiments of the present invention provide various monopole radiators that advantageously balance azimuth performance and extremely broad band operation in relatively low-power transmitting systems. The antennas perform well over low and high band cellular telephony and the various frequencies used by ZIGBEE®, BLUETOOTH®, Z-WAVE®, and other communication devices in a variety of locations world-wide.

A monopole with ground plane has a bandwidth over which it can efficiently transmit or receive EM signals. The transmitting efficiency is a characteristic of the monopole's complex impedance matching to a source/transmission system on the feed side, and to the monopole's coupling to free space on the radiation side. Impedance matching is commonly measured in terms of voltage standing wave ratio (VSWR), which is a comparison between applied and reflected signal energy measured in terms of voltages from a narrow-band, swept-spectrum transmitter to an antenna. An ideal VSWR is defined as 1.0:1; antennas with VSWR as high as 2.0:1 or considerably greater are usable for some applications, particularly low-power transmitters and high-gain receivers. It is to be understood that energy reflected back from an antenna with a higher VSWR must be diverted from or tolerated by its transmitter.

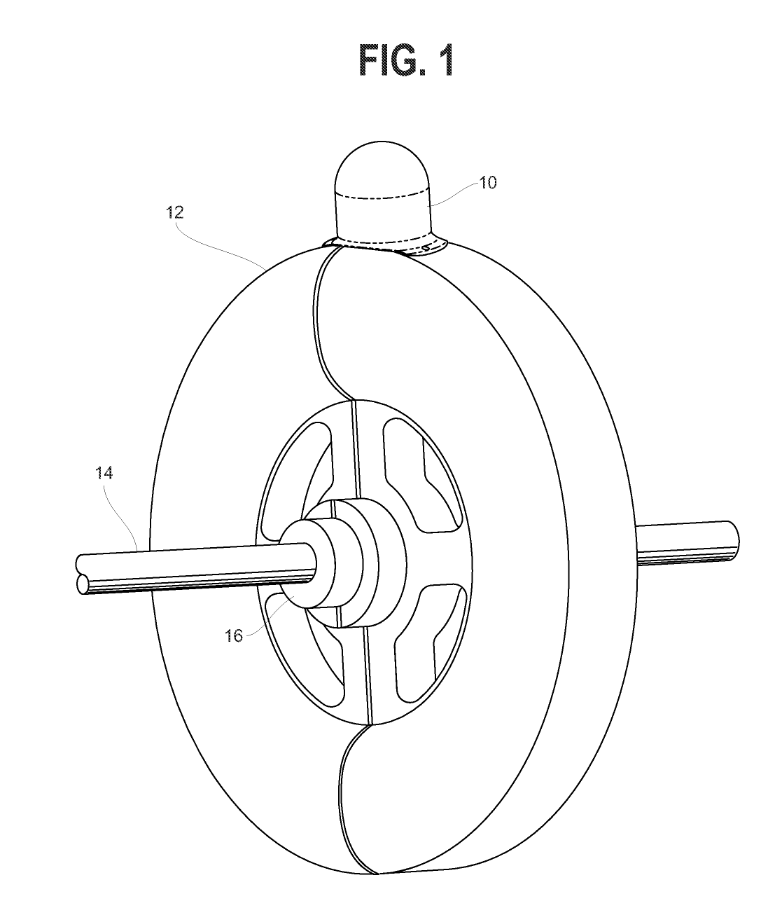

FIG. 1 shows an antenna 10 according to an embodiment of the invention, mounted on data acquisition and telemetry system 12 which surrounds a power conductor 14. Despite being generally toroidal in shape, the data acquisition and telemetry system 12 is discouraged from rotating by a substantial weight bias toward its bottom, and remains fixed along the power conductor 14 by means of a fitting 16 clamped onto the power conductor 14.

Any of a variety of sense functions may be incorporated within data acquisition and telemetry system 12 arranged generally like the one shown. The measured data include, for example, voltage, current, temperature, tension, line sag, power factor, electrical noise outside the power line's nominal spectrum, the presence of broadcast signal energy induced into the power conductor 14, etc., and are captured by a processor-based, data acquisition and storage subsystem (not shown). Power to operate data acquisition and telemetry system 12 may be extracted from the field gradient present in proximity to the power conductor 14, and optionally stored in a rechargeable battery subsystem. Voltages at least as high as 750 KV may be present on a representative monitored power conductor 14, providing an ample gradient. At predetermined intervals, in response to sensing specific types of transmission line problems, in response to polling by a central site, etc., the data acquisition and telemetry system 12 connects to the central site, via a cellular network for example, and transmits the acquired data.

In a cellular telephony context, each data acquisition and telemetry system 12 acquires at least one unique identity in the form of a Mobile Identification Number (MIN), which is ten decimal digits in the U.S., directly equivalent to a land line telephone number, assigned at least temporarily during the process of manufacturing, distributing, installing, or activating data acquisition and telemetry system 12. There is likely to be at least a second unique identifier, an Electronic Serial Number (ESN), typically eight hexadecimal digits, embedded in that data acquisition and telemetry system 12 from the time of manufacture, and including manufacturer identity bits as well as production code information. If current types of consumer cellular telephone apparatus are used, there may also be Global Positioning System (GPS) capture capability, allowing the physical location of data acquisition and telemetry system 12 to be verified each time data is acquired. In addition to this, the communication process delivers to the central site at least one cellular tower location datum, which may be used to confirm the GPS data. Thus, from the time of installation, data acquisition and telemetry system 12 can positively affirm its location as well as sensing the condition of the power line 14.

In addition to cellular communication, data acquisition and telemetry system 12 can be configured to communicate directly with, for example, a data transceiver operated by a maintenance worker visiting the location of data acquisition and telemetry system 12. Typical unlicensed radio services for very short range communication include ZIGBEE®, Z-WAVE®, BLUETOOTH®, etc. Any of these and others may be supported by the inventive antenna, which has sufficient bandwidth to support all of them in addition to the low and high band cellular telephone services licensed in the U.S. and the rest of the world.

As an alternative to cellular telephony, any established commercially licensable radiotelephone service may be preferred for specific applications. Services are feasible on a variety of frequency ranges, and may use an implementer duplicate the combination of towers, antennas, transceivers, tower-to-tower communication links, and data management resources already implemented by cellular providers.

To the extent that non-cellular services operate in spatial arrangements and frequency domains similar to those of cellular systems, antennas according to the invention may be directly applicable. For services such as some types of satellite-based communications, where a transmitter may be in low earth orbit and thus located at any elevation from horizon to zenith, it may be necessary to adapt antenna geometry as well as size to provide sufficient gain at all elevation angles. For example, satellite-based communication systems are available, such as Iridium, GLOBALSTAR®, ORBCOMM®, SkyWave, BGAN, TDRSS, and the like, capable of providing virtually total world coverage without additional build out. BGAN, TDRSS, and some other services are geosynchronous, and thus at a fixed elevation relative to a specific installation. Since geosynchronous satellites also operate at fixed azimuths and have different gain and signal power requirements than terrestrial systems, directional versions of the invention may be preferred for such applications.

Generally, antenna 10 includes a monopole radiator disposed over a ground plane and an RF signal connector coupled to the monopole radiator. Antenna 10 is highly effective over all azimuths, while having low weight, simple construction, and exceptional broadband capability.

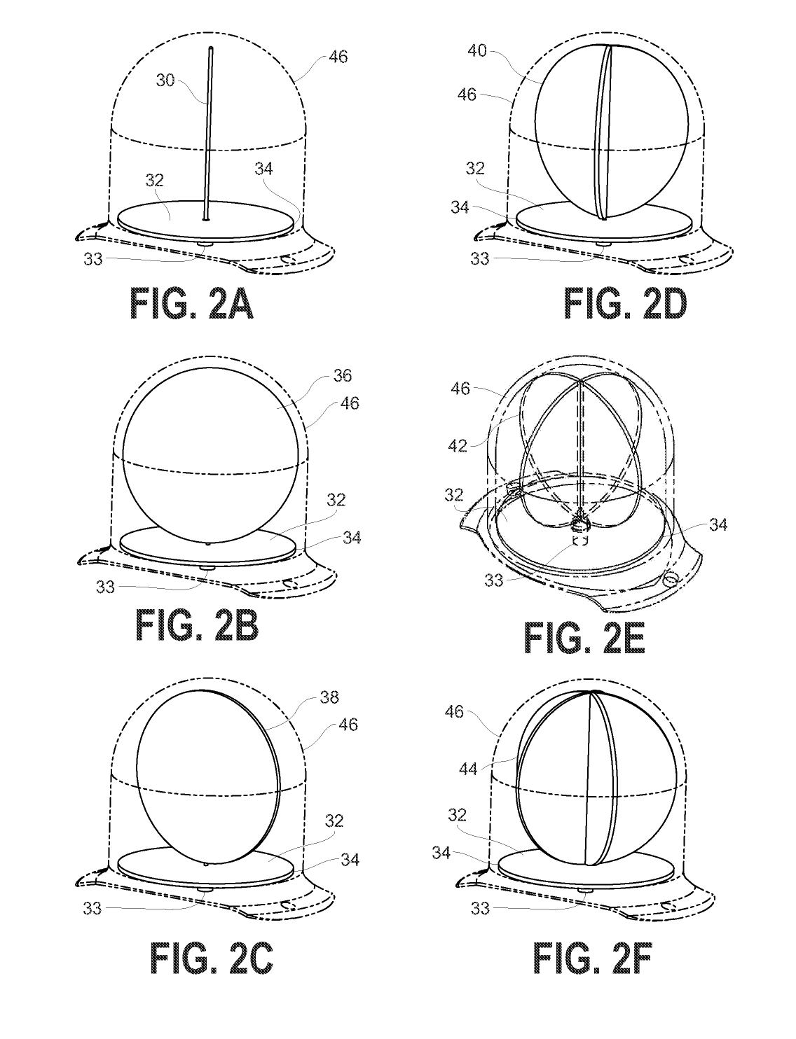

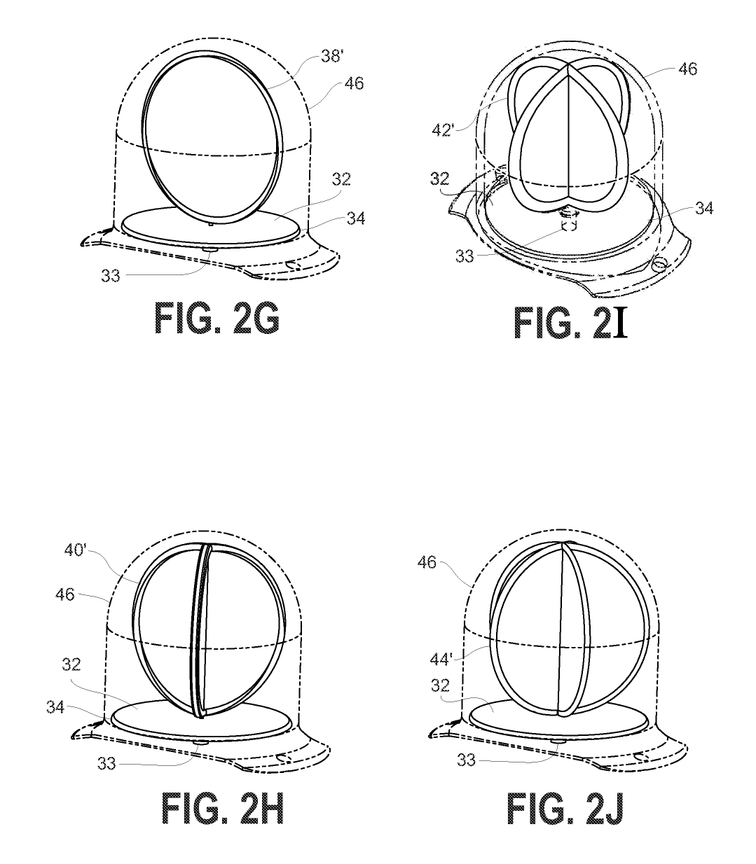

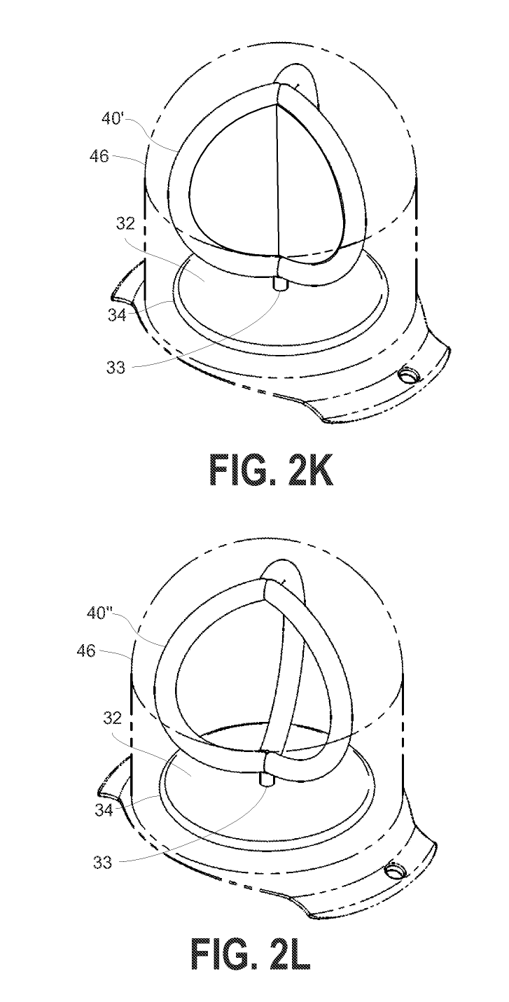

FIG. 2A shows a cylindrical monopole radiator 30, disposed over a substantially circular ground plane 32, and an RF signal connector 33 coupled to the monopole radiator 30, according to an embodiment of the invention. The monopole radiator 30 is terminated with a smoothly-radiused top, while the ground plane 32 has a smoothly-radiused edge 34. This embodiment exhibits excellent VSWR at optimum frequency. Other embodiments include, for example, a ball on top of monopole radiator 30, further decreasing curvature at the highest point.

FIG. 2B shows a spherical monopole radiator 36, disposed over a substantially circular ground plane 32, and an RF signal connector 33 coupled to the monopole radiator 36, according to an embodiment of the invention. The ground plane 32 has a smoothly-radiused edge 34. In comparison to the embodiment of FIG. 2A, the monopole radiator 36 has an increased frequency range over which its VSWR is fairly uniform.

FIG. 2C shows a flat, circular monopole radiator 38, disposed over a substantially circular ground plane 32, and an RF signal connector 33 coupled to the monopole radiator 38, according to an embodiment of the invention. The monopole radiator 38 includes a flat circular plate having a certain thickness, an outer edge and two flat faces. The ground plane 32 has a smoothly-radiused edge 34. In one embodiment, the diameter of monopole radiator 38, e.g., the height above the ground plane 32, is equal to the quarter-wave dimension for a frequency near the middle of the antenna's working range. Generally, the diameter is selected for compatibility with the desired (very broad) bandwidth, allowing the same antenna to be used without alteration for low and high cellular ranges and short-range unlicensed radios, as discussed above. The monopole radiator 38 has very good VSWR over the desired range, and is relatively inexpensive to fabricate. In an alternative embodiment, the flat circular monopole radiator 38 could be formed from two, flat semicircular elements that are joined together.

FIG. 2G depicts another embodiment of a single-element monopole radiator 38′ in which the outer edge includes a cylindrical rim whose diameter is greater than the thickness of the plate. This embodiment advantageously reduces corona effects and improves radiation and impedance performance. In one embodiment, the cylindrical rim diameter is much greater than the plate thickness, such as, for example, three to five times greater; greater relative dimensions are also contemplated. In an extreme embodiment, the thickness of the plate approaches zero, such that the cylindrical rim governs performance.

FIG. 2D shows a monopole radiator 40, disposed over a substantially circular ground plane 32 with a smoothly-radiused edge 34, and an RF signal connector 33 coupled to the monopole radiator 40, according to an embodiment of the invention. The monopole radiator 40 includes three flat semicircular plates, each plate having a certain thickness, a straight inner edge, a semicircular outer edge and two flat faces. The elements form a common vertical axis along their respective inner edges, and are symmetrically arranged about this vertical axis. The monopole radiator 40 advantageously provides a gain variation over all azimuths that is less than 5 dB; in other words, omnidirectionality. Its VSWR is noticeably higher than that of monopole radiator 38 over some parts of its frequency range. Modeling the performance of monopole radiator 40 (discussed below) involved, inter alia, representing each flat plate as a discrete, well-known radiator, such as a curved cylinder.

FIGS. 2H and 2K depict another embodiment of a three-element monopole radiator 40′ in which the outer edge of each plate includes a cylindrical rim whose diameter is greater than the thickness of the plate. This embodiment advantageously reduces corona effects and improves radiation and impedance performance. FIG. 2L depicts a further embodiment in which monopole radiator 40″ only includes the cylindrical rim of each plate, i.e., the thickness of the flat portion of each plate has been reduced to zero, leaving three curved cylinders. The three cylindrical rims of monopole radiator 40′ are joined at their respective end portions, in a manner suggested by modeling the performance of monopole radiator 40. Reductions in corona effects and improvements in performance are also provided by this embodiment.

FIG. 2E shows a monopole radiator 42, disposed over a substantially circular ground plane 32 with a smoothly-radiused edge 34, and an RF signal connector 33 coupled to the monopole radiator 42, according to an embodiment of the invention. The monopole radiator 42 includes four flat semicircular plates, each plate having a certain thickness, a straight inner edge, a semicircular outer edge and two flat faces. The elements form a common vertical axis along their respective inner edges, and are symmetrically arranged about this vertical axis. This embodiment has a strong azimuthal uniformity and adequate bandwidth. Modeling the performance of monopole radiator 42 (discussed below) involved, inter alia, representing each flat plate as a discrete, well-known radiator, such as a curved cylinder.

FIG. 2I depicts another embodiment of a four-element monopole radiator 42′ in which the outer edge of each plate includes a cylindrical rim whose diameter is greater than the thickness of the plate. This embodiment advantageously reduces corona effects and improves radiation and impedance performance.

FIG. 2F shows a monopole radiator 44, disposed over a substantially circular ground plane 32 with a smoothly-radiused edge 34, and an RF signal connector 33 coupled to the monopole radiator 44, according to an embodiment of the invention. The monopole radiator 44 includes five flat semicircular plates, each plate having a certain thickness, a straight inner edge, a semicircular outer edge and two flat faces. The elements form a common vertical axis along their respective inner edges, and are symmetrically arranged about this vertical axis. This embodiment has a strong azimuthal uniformity and adequate bandwidth. Modeling the performance of monopole radiator 44 (discussed below) involved, inter alia, representing each flat plate as a discrete, well-known radiator, such as a curved cylinder.

FIG. 2J depicts another embodiment of a five-element monopole radiator 44′ in which the outer edge of each plate includes a cylindrical rim whose diameter is greater than the thickness of the plate. This embodiment advantageously reduces corona effects and improves radiation and impedance performance.

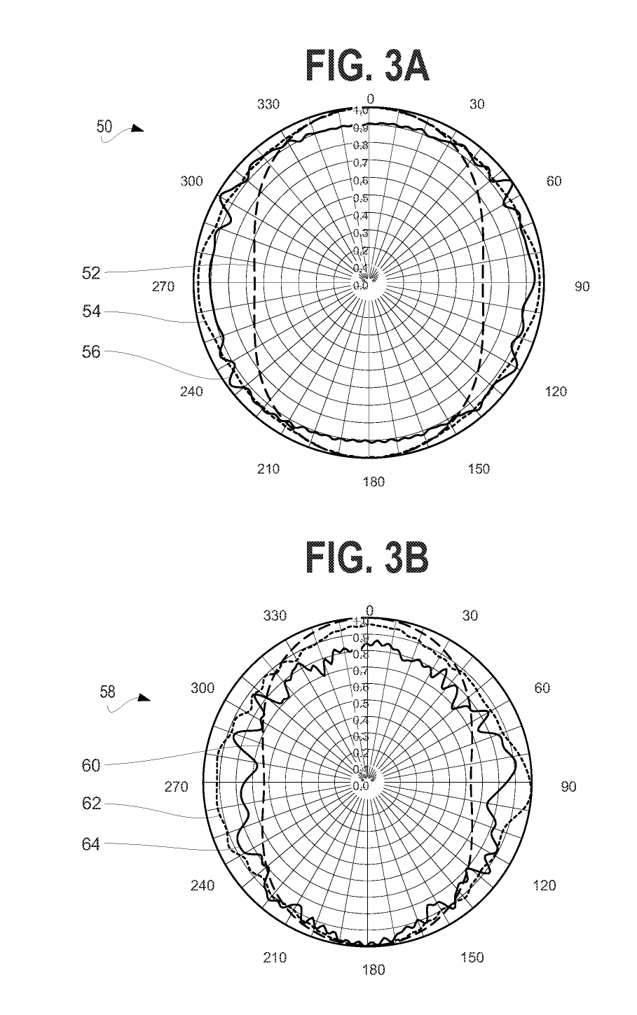

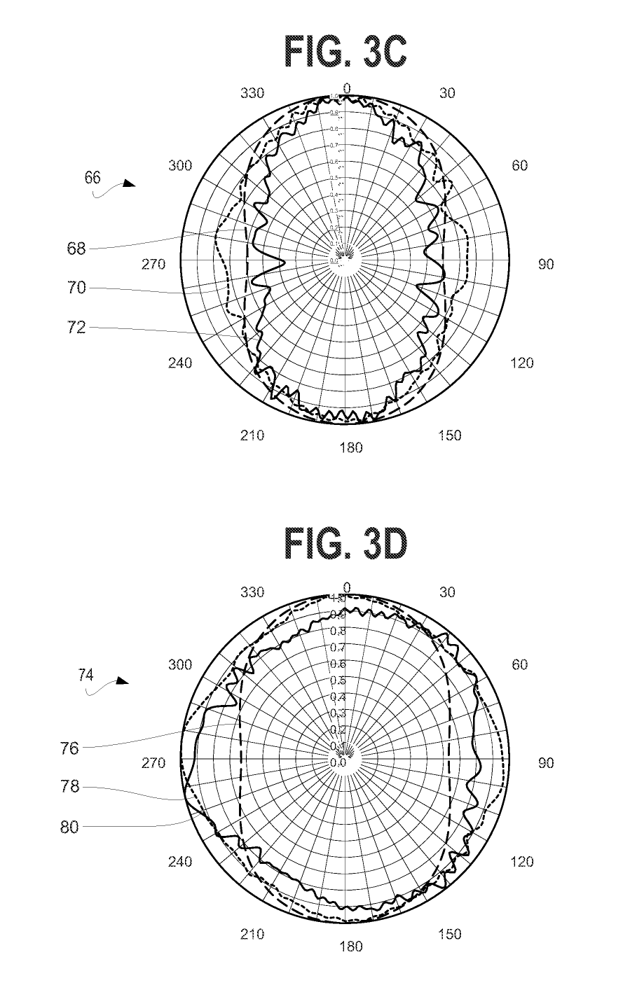

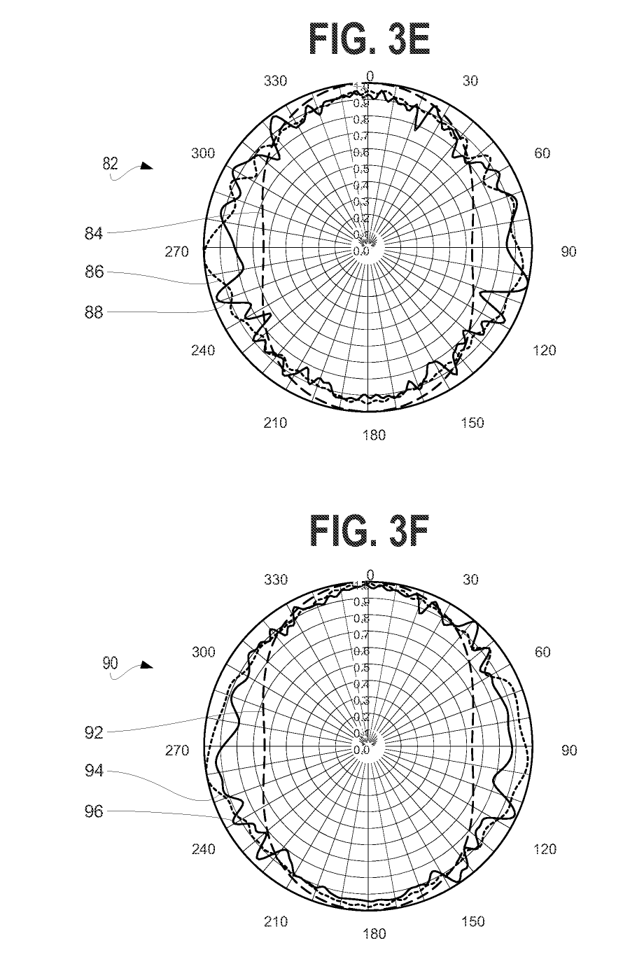

FIGS. 3A-3F show gain-vs-azimuth plots 50, 58, 66, 74, 82 and 90 for the monopole radiators 30, 36, 38, 40, 42 and 44 shown in FIGS. 2A-2F, respectively.

FIG. 3A shows a gain-vs-azimuth plot 50 for monopole radiator 30 including gain pattern 52 for a low-end frequency, 925 MHz, gain pattern 54 for a mid-range frequency, 1795 MHz, and gain pattern 56 for a high-end frequency, 2440 MHz. Both the mid-range and high frequency gain patterns 54, 56 are seen to be largely omnidirectional for the monopole radiator 30, which is anticipated for a radially-symmetric radiator.

FIG. 3B shows a gain-vs-azimuth plot 58 for monopole radiator 36 including gain patterns 60, 62, and 64, for low, mid, and high frequencies, 925 MHz, 1795 MHz, and 2440 MHz, respectively, which closely resemble those of monopole radiator 30.

FIG. 3C shows a gain-vs-azimuth plot 66 for monopole radiator 38 including gain patterns 68, 70, and 72, for low, mid, and high frequencies, 925 MHz, 1795 MHz, and 2440 MHz, respectively, which are affected by radiator geometry to a greater extent than the gain patterns of monopole radiators 30, 36.

FIG. 3D shows a gain-vs-azimuth plot 74 for monopole radiator 40 including gain patterns 76, 78, and 80, for low, mid, and high frequencies, 925 MHz, 1795 MHz, and 2440 MHz, respectively, which are largely omnidirectional and somewhat triangular.

FIG. 3E shows a gain-vs-azimuth plot 82 for monopole radiator 40 including gain patterns 84, 86, and 88, for low, mid, and high frequencies, 925 MHz, 1795 MHz, and 2440 MHz, respectively, which are largely omnidirectional and somewhat square.

FIG. 3F shows a gain-vs-azimuth plot 90 for monopole radiator 42 including gain patterns 92, 94, and 96, for low, mid, and high frequencies, 925 MHz, 1795 MHz, and 2440 MHz, respectively, which are largely omnidirectional.

It will be observed that gain patterns at the low end of the analyzed ranges are relatively insensitive to radiator geometry. This is a consequence of the presence of a large metallic mass making up a significant portion of the data acquisition and telemetry system 12, located beneath the radiator 10, and oriented in the same way for each embodiment. The patterns may be anticipated to vary for applications not using sensors with comparable magnitude and placement of conductive mass.

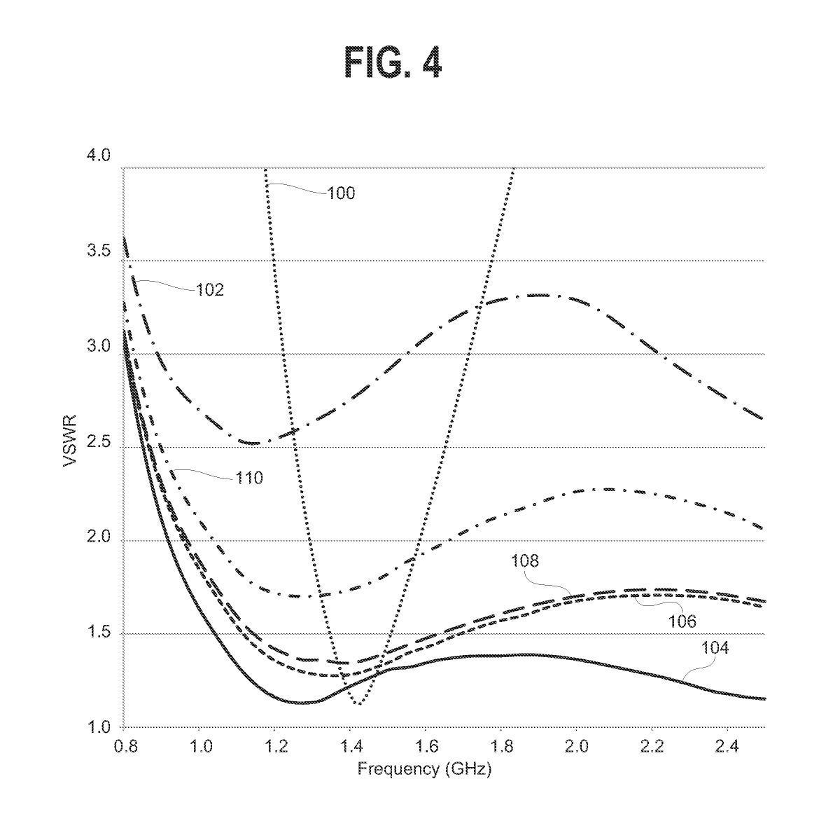

FIG. 4 shows VSWR plots for the embodiments of FIGS. 2A, 2B, 2C, 2D, 2E, and 2F. From these, the narrow low-VSWR bandwidth 100 of monopole radiator 30, the very broad low-VSWR bandwidth 104 of monopole radiator 38, and the similar VSWR bandwidths 106, 108 and 110 of the three-element, four-element and five-element radiators 40, 42 and 44 (respectively) are apparent. The VSWR bandwidth 102 of monopole radiator 36 is also presented for comparison. While such a plot of VSWR as driven by number of elements is not the only criterion a user may consider in selecting a configuration, it illustrates, like gain vs azimuth, the relative performance of a variety of high-voltage-compatible monopoles.

The inventive antenna advantageously offers maximum omnidirectionality, maximum VSWR bandwidth, minimum cost, as well as a balance between these performance factors. Each of these factors may also be seen as an optimization parameter, and a manufacturer may further choose to consider tradeoffs in product line complexity when choosing which embodiment to offer for sale.

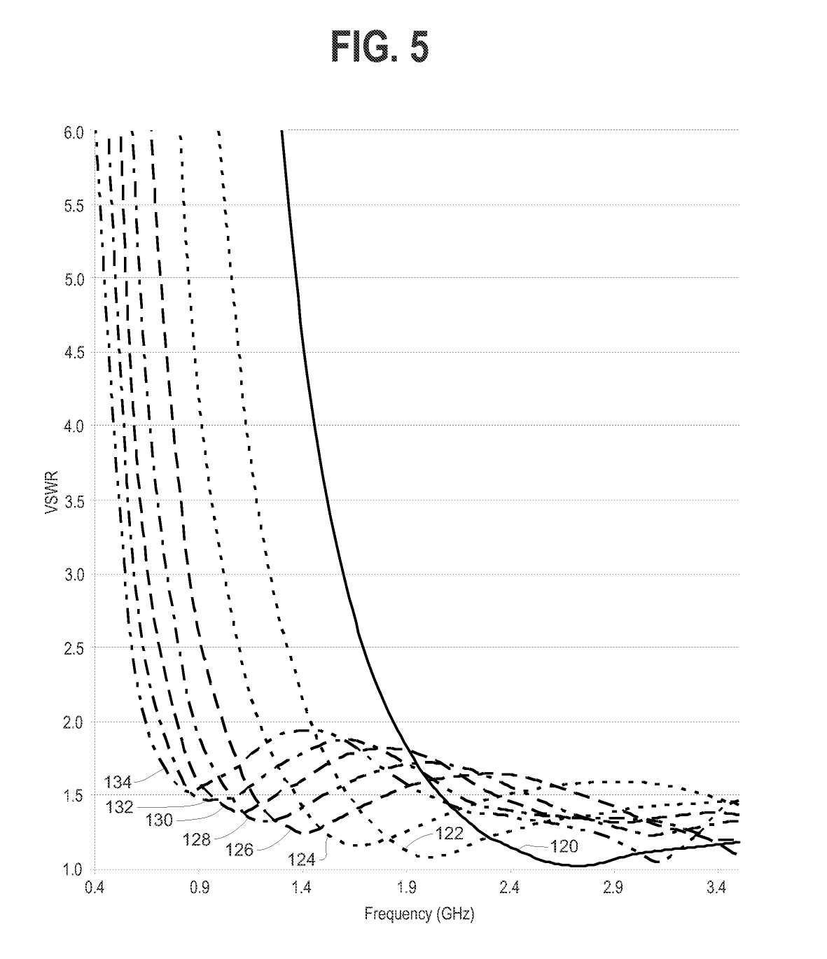

FIG. 5 shows performance vs. diameter for a range of disk sizes for monopole radiator 38 (depicted in FIG. 2C). Sizes shown are 3 cm (1.2 in) 120, 4 cm (1.6 in) 122, 5 cm (2.0 in) 124, 6 cm (2.4 in) 126, 7 cm (2.8 in) 128, 8 cm (3.2 in) 130, 9 cm (3.5 in) 132, and 10 cm (4.0 in) 134. The figure shows that the smallest disk 120 performs poorly below about 1.3 GHz (VSWR=6), while the largest 134 performs at the same VSWR level at 400 MHz. FIG. 4 suggests that other radiator configurations perform proportionately, albeit with VSWR values that tend to be higher at all frequencies.

Each disk size also has at least one minimum VSWR within the plotted range. The lowest of all is the smallest disk, the minimum VSWR of which falls at a higher frequency than the range of interest. Thus, low-end VSWR, minimum VSWR, working range, and physical size may be considered in selecting a radiator size, even for the wide-bandwidth antenna disclosed herein. One preferred embodiment is about 6.5 cm (2.6 in) in diameter, with performance falling between that for 6 cm 126 and 7 cm 128. This embodiment crosses the VSWR=6 threshold around 630 MHz, has a minimum VSWR around 1.3 that falls around 1.3 GHz, and never exceeds a VSWR of 2 below 3.5 GHz, i.e., between 1 GHz and 3.5 GHz. The superior omnidirectionality of the three-element and four-element embodiments may outweigh the superior VSWR of the single disk.

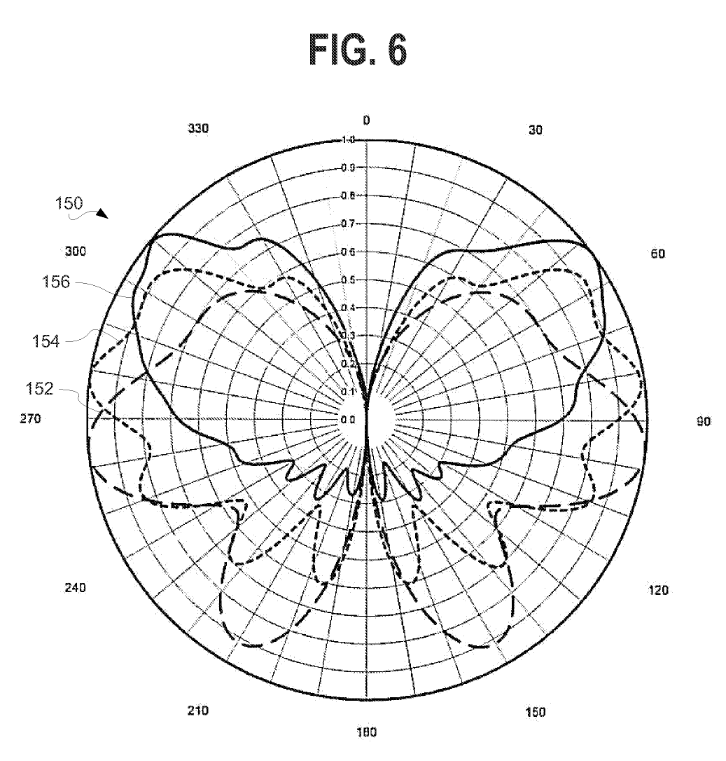

FIG. 6 is a plot 150 showing gain vs elevation at low 152, moderate 154, and high 156 frequencies for monopole radiator 40; similar performance is predicted for monopole radiators 42, 44. This shows that signals strength directly below data acquisition and telemetry system 12, with antenna 10 on its top, is generally very attenuated. Within about 10° to 30°, however, there are lobes even at the highest frequencies of interest that are around −10 dB, which may be ample for ZIGBEE® or other form of communication. Signal strength at the zenith is quite low, which is not a factor for terrestrial communication.

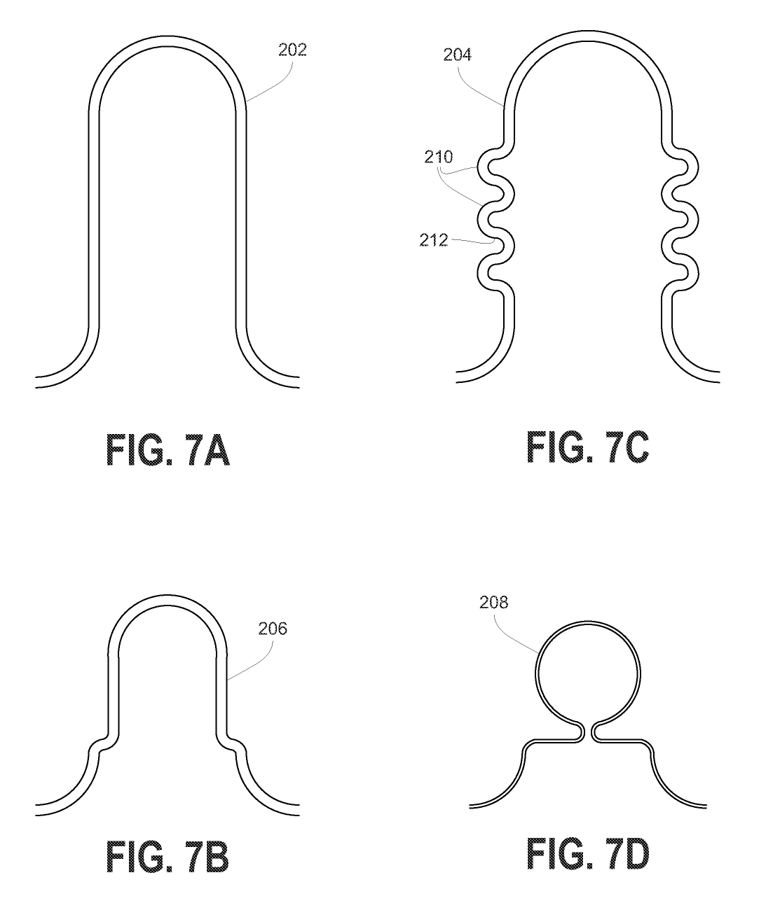

FIGS. 7A-7D shows radomes 202, 204, 206 and 208 according to embodiments of the present invention. In view of the expected environment for the antenna 10, in which high AC voltage relative to the surrounding space and a high field gradient are permanent conditions, different shapes may be advantageous, such as, for example, a smooth radome 202, a long creepage length radome 204, a closely conformal radome 206, embedment of the conductive components in insulating material 206, etc.

Where it is preferred to establish a long creepage length for the radome 204 to the extent practical, a series of smooth, circumferential corrugations 210 increases the length over which contaminants would need to accumulate in order to establish a conductive path. Areas 212 overhung by others would less readily acquire dust. In more extreme configurations, corrugations termed “sheds” (not shown) can overhang sufficiently to block some parts of the surface virtually entirely. A tradeoff in any extent of corrugation is its effect on signal propagation. For example, a simple shape minimizes the amount and variation in the amount of material having a different dielectric constant than air, and thus altering propagation. Very thin insulating coatings or exposure of the radiator itself to air may represent feasible alternatives, at least for short duration use in minimal-contaminant environments such as deserts.

Materials for radome 46 (FIG. 2) have good resistance to deterioration when subjected to high voltage and to weather, such as sun, rain, salt, and chemical pollutants, for example. The materials should also have low conductivity and reasonably low loss tangent, e.g., energy absorption and dissipation. Thin walls may be used to keep the scale of any losses low as well as to keep any RF signal propagation path distortion associated with the material's dielectric constant low. Uniform shape with azimuth, i.e., symmetry about a vertical axis of rotation in the portion of radome 46 exposed to the transmitted and received signals, is likewise helpful in maintaining omnidirectionality. A typical useful material for this application is acrylonitrile butadiene styrene (ABS), a thermoplastic copolymer of the named constituents having good electrical and mechanical properties. This material can be reinforced with fiber or other filler and treated with additives that enhance resistance ultraviolet (UV) light, e.g., sunlight, and pollutants. Prudence suggests that a selected combination of polymer, additives, and filler be proved suitable by a directly relevant RF, UHV, and UV history or rigorous analysis and test.

The monopole radiators can be formed from a variety of conductive materials, such as, for example, copper, aluminum, brass, etc., and shaped and/or joined using a variety of processes, such as, for example, casting, soldering, etc. Cellular telephone antennas for personal mobile use commonly employ a simple circuit-board-style conductive trace on flexible insulating material such as polyimide film, so any material adaptable to a high-voltage environment may be usable. An example is cast zinc, which is sufficiently conductive and durable, easy to manufacture, and inexpensive. Other materials may include molded plastic, either solid or foamed, that can be treated or coated to be conductive, semi-conductive materials such as carbon fiber, etc. Considerations in material choice include long-term stability and voltage withstand.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to that fall within the scope of the invention.

What is claimed is:

1. A broad-band monopole antenna for high voltage environments, comprising:
a ground plane including a flat upper surface, a lower surface, a smoothly-radiused outer edge and a hole centrally disposed through the upper and lower surfaces;
a plurality of flat radiator elements, each having a thickness, a straight inner edge and a semicircular outer edge, interconnected along each inner edge and symmetrically arranged about a vertical axis centered on the ground plane hole; and
an electrical connector, extending through the ground plane hole, coupled to the radiator elements.

2. The monopole antenna of claim 1, wherein the ground plane is substantially circular.

3. The monopole antenna of claim 1, wherein the plurality of flat radiator elements consists of three flat radiator elements.

4. The monopole antenna of claim 1, wherein the plurality of flat radiator elements consists of four flat radiator elements.

5. The monopole antenna of claim 1, wherein the plurality of flat radiator elements consists of five flat radiator elements.

6. The monopole antenna of claim 1, further comprising a radome.

7. The monopole antenna of claim 6, wherein the radome includes a curved surface, enclosing the plurality of radiator elements and the ground reference plate, and a plurality of uniform corrugations parallel to the vertical axis.

8. The monopole antenna of claim 1, wherein each of the plurality of flat radiator elements includes a cylindrical rim, extending along the length of the outer semicircular edge, having a diameter greater than the thickness of the flat radiator element, and wherein the upper ends of the cylindrical rims are interconnected and the bottom ends of the cylindrical rims are interconnected.

9. The monopole antenna of claim 8, wherein the diameter of each cylindrical rim is at least three times greater than the thickness of each flat radiator element.

10. The monopole antenna of claim 9, wherein the thickness of the flat radiator element is substantially negligible compared to the diameter of the cylindrical rim.

11. The monopole antenna of claim 10, wherein the radiative performance of the monopole antenna is substantially controlled by the cylindrical rims.

12. A broad-band monopole antenna for high voltage environments, comprising:
a ground plane including a flat upper surface, a lower surface, a smoothly-radiused outer edge and a hole centrally disposed through the upper and lower surfaces;
a single flat radiator, having a thickness and a circular outer edge, arranged about a vertical axis centered on the ground plane hole; and
an electrical connector, extending through the ground plane hole, coupled to the radiator.

13. The monopole antenna of claim 12, wherein the ground plane is substantially circular.

14. The monopole antenna of claim 12, further comprising a radome.

15. The monopole antenna of claim 12, wherein the flat radiator includes a cylindrical rim, extending along the length of the outer edge, having a diameter greater than the thickness of the flat radiator.

16. The monopole antenna of claim 15, wherein the diameter of the cylindrical rim is at least three times greater than the thickness of the flat radiator element.

17. The monopole antenna of claim 16, wherein the thickness of the flat radiator element is substantially negligible compared to the diameter of the cylindrical rim.

18. The monopole antenna of claim 17, wherein the radiative performance of the monopole antenna is substantially controlled by the cylindrical rim.
